(19) United States
(12) Patent Application Publication
(10) Pub. No.: US 2006/0073740 A1
(43) Pub. Date: Apr. 6, 2006

(54) Securing part for a screw connection

(76) Inventors: Johann Schuster, Oberasbach (DE); Stefan Stocker, Grossenseebach (DE)

Correspondence Address: SIEMENS COPORATION;INTELLECTUAL PROPERTY DEPARTMENT, 170 WOOD AVENUE, SOUTH, ISELIN, NJ, 08830, US

(21) Appl. No.: 11/240,594

(22) Filed: Sep. 30, 2005

(30) Foreign Application Priority Data
Oct. 1, 2004 (DE) 10 2004 048 384.1

(51) Int. Cl. H01R 4/50

(52) U.S. Cl. 439/807

(57) ABSTRACT

The invention relates to a securing part to prevent a screw connection working loose, in which a first part is screwed to a second part with a screw, with the securing part featuring attachment means for attaching the securing part to one of the parts or to the screw and being embodied such that in a secured state of the screw connection it is fixed spatially relative to one of the parts and relative to the screw. In one embodiment the securing part is screwed to the screw. The securing part is in this case U-shaped and grips two sides of the screw head and the two sides of the part adjoining the screw head, which for example is embodied as a cable shoe or the washer below it.

### CROSS REFERENCE TO RELATED APPLICATIONS

This application claims priority to the German application No. 10 2004 048 384.1, filed Oct. 1, 2004 which is incorporated by reference herein in its entirety.

### FIELD OF INVENTION

The invention relates to a securing part to prevent a screw connection from working loose, in which a first part is secured to a second part by a screw.

### BACKGROUND OF INVENTION

The securing of screw connections against undesired loosening is of decisive importance for power connections in particular. The problem is illustrated using magnetic resonance technology as an example. Thus, for example, in a magnetic resonance device what are known as gradient coils are supplied with high currents of up to 650 A which vary over time. To this end a cable shoe is screwed to a gradient terminal of the gradient coil. This screw connection must be secured against undesired loosening in order to prevent fire damage for example. The currents flowing are switched as unipolar or bipolar currents in sine wave or trapeze form, with rise times ranging from ms to a few Its. The power connection of these coils is dictated by the construction within the strong basic field of a basic field magnet of the magnetic resonance device. The proximity of the screw connection to the magnetic windings means for example that, with a 1.5 Tesla magnetic resonance device, field strengths of up to 3 Tesla are possible. Therefore strong opposing forces operate on the connections. In addition the gradient coil vibrates during operation from the Lorentz forces operating on the coil leads with a phase and oscillation amplitude which differs from that of the magnetic housing. However the gradient leads are connected to the magnetic housing. These relative movements produced additionally lead to dynamic changes in the load which have an effect on the terminal connection. If the screw connection becomes loose under some circumstances the contact resistance can increase. The high currents then cause losses to occur which can lead to the connecting cable and/or the gradient-side connections catching fire.

### SUMMARY OF INVENTION

An object of the invention is thus to secure a screw connection, i.e. to prevent the screw connection working loose and thus for example to contribute to reducing the dangers for the screw connection.

In accordance with the invention this object is achieved by a securing part with attachment means for attaching the securing part to one of the parts to be screwed together or to a screw which connects the two parts, with the securing part being embodied such that, in a secured position of the screw connection, it is fixed spatially relative to one of the parts and relative to the screw.

The means of attachment can for example feature a securing screw with which the securing part can be screwed to a screw head of the screw. In another embodiment the attachment means can act as a click element, in which case securing hooks of the attachment element hook into one of the parts such that the securing part is spatially fixed.

In accordance with the invention the securing part is embodied such that in the secured state of the screw connection, i.e. After the screw has been tightened and the securing part attached, a relative movement of the screw in relation to at least one of the parts is suppressed. In a particular embodiment a first area of the securing part is arranged in this case in the screw direction next to the screw head and in contact with the latter. In a further development the first area is embodied as a surface and it is arranged next to a side surface of the screw head. If the gap is only small this prevents the screw from turning.

Similarly the relative movement of the securing part in relation to one of the parts can be prevented. To this end, in the attached state of the securing part at least one second area of the securing part is in contact with one of the parts. For example the second area also has a smooth surface which in the secured state is arranged in the screw direction next to the part, in which case the part is especially embodied in the shape of a plate with side surfaces, e.g. as a cable shoe. Alternatively the securing part could for example be embodied in the form of a pin in the second area and in the se cured state project into one of the parts in order to prevent it turning.

In an advantageous embodiment of the invention the securing part is embodied as an angled part, with one side area of the angled securing part being able to be screwed into a screw head with a thread and the other side area extending over the screw head and over the part adjoining the screw head and fixing the screw head and the part to each other. In a further development the securing part can be embodied in a U shape and on two op posing sides of the screw head for example fixes the latter against the part adjoining the screw head, in which case, especially as an alternative to screwing on the securing part, the two sides of the U-shape can be embodied as a click element with securing hooks.

The advantages of the invention lie in the fact that it is simple to implement, cheap to manufacture and provides the option of adapting the securing part for a very wide variety of screw connections, in that the securing part, under some circumstances together with a new screw with integrated thread can be screwed into these screws. With the securing part a high degree of security is obtained for the screw connection to prevent dangerous cable fires for example.

Further advantageous embodiments of the inventions are identified by the features of the dependent claims.

### BRIEF DESCRIPTION OF THE DRAWINGS

Two typical embodiments of the invention are explained below with reference to FIGS. 1 to 6. The figures show

FIG. 1 a perspective view of a screw connection with securing part,

FIG. 2 a view of the screw connection from FIG. 1,

FIG. 3 a side view of the screw connection from FIG. 1,

FIG. 4 a cross-section through the screw connection from FIG. 1,

FIG. 5 a securing part for clicking onto a cable shoe screw connection and

FIG. 6 a securing part with pins.

### DETAILED DESCRIPTION OF INVENTION

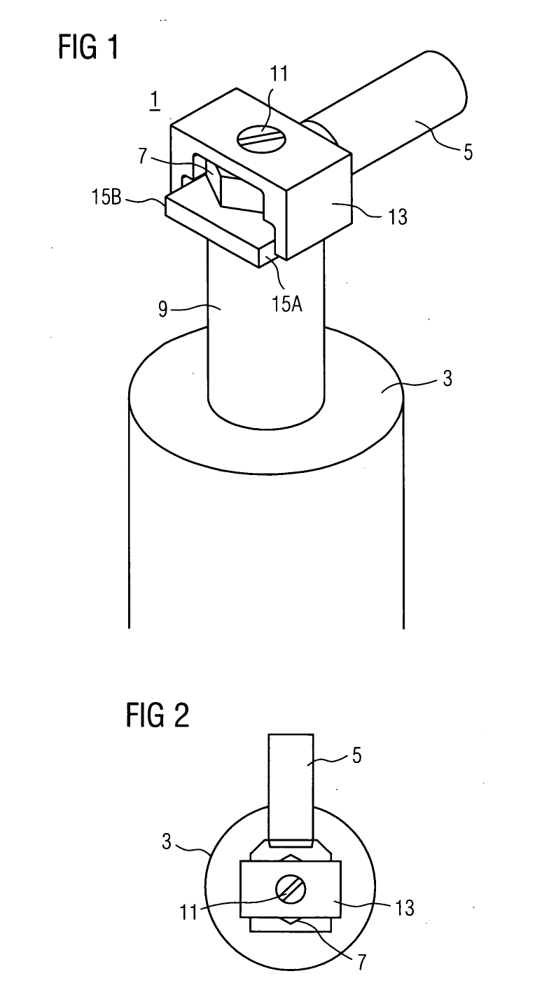

FIG. 1 illustrates a screw connection 1 secured in accordance with the invention using the power connection to a gradient magnet as an example. In this case a cable is connected to a gradient terminal 3 using a cable shoe 5. The gradient terminal is made of massive copper, brass or stainless steel for example, and is thus non-magnetic and compatible with magnetic resonance devices. The gradient terminal 3 projects out of an epoxy molding of the gradient coil unit. The face of the gradient terminal 3 embodied as a socket is the contact point for the terminal.

The cable shoe 5 is screwed onto the gradient terminal 7 with a screw head 7. A spacer 9 which is not absolutely necessary holds the cable shoe 5 and the gradient terminal 3 at a distance. In FIG. 1 the screw head 7 can be seen to which a securing part 13 is secured with a securing screw 11.

The screw is typically an M10 screw. In FIG. 1 the securing part is embodied in a U shape and extends over the cable shoe 5 and at the same time over the screw head 7. The screw head 7 is thus fixed in its position relative to the cable shoe 5. The securing screw 11 can additionally be secured against working loose by a locking agent e.g. LOCTITE, something which is not recommended for screw connection 1 since the locking agent creeps into the contact surface of the screw connection and increases the contact resistance. The screw can in addition be provided with a shakeproof washer in accordance with the prior art which is fitted between screw head 7 and cable shoe 5. When the cable shoe 5 is screwed on this is thus first attached via the screw with the shakeproof washer (not visible) to the gradient terminal 3 and tightened to the appropriate torque (typ. 22 Nm). Then the hexagonal screw head 7 is aligned with its wrench faces in parallel to cable shoe sides 15A, 15B. This is brought about by an additional slight tightening up to a maximum of 30°. After this the U-shaped securing part can be placed over the screw head 7 and cable shoe 5 and attached using the securing screw 11. Accordingly this prevents the screw turning relative to the cable shoe 5.

FIG. 2 shows a view from above of the screw connection 1 from FIG. 1. It can be seen that the width of the securing part 13 is greater than that of the cable shoe 5, so that the securing part 13 can extend over the side walls 15A, 15B. In FIG. 1 the step-shaped embodiment of the securing part 13 can be seen from the inner sides of the U shape, so that the inner side walls of the securing part are arranged in each case next to the sides of the screw head 7 or the side walls 15A, 15B of the cable shoe 5 in the secured state.

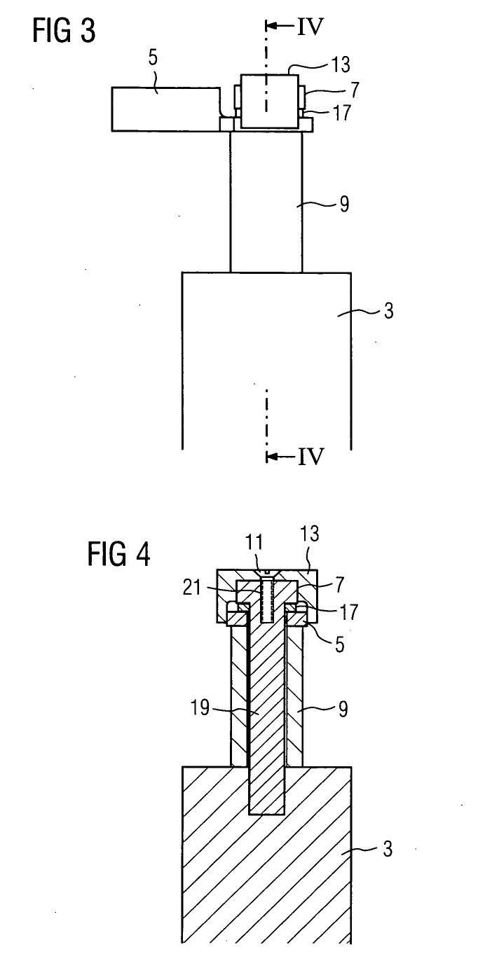

FIG. 3 shows a side view of the screw connection 1 from FIG. 1 in which in addition a washer 17 can be seen between screw head 7 and cable shoe 5.

FIG. 4 now shows a cross section through the screw connection 1 in which the screw 19 can be seen which is screwed into a thread in the gradient terminal 3 and which features a thread 21 in the screw head 7 of the screw 19. The securing screw 11 is screwed into the thread 21 to attach the securing part 13. The securing part 13 can be made of stainless steel or brass in order to be compatible with magnetic resonance devices and resistant to high temperatures for example.

For use at lower temperatures a click-on securing part 13A may be sufficient for example, as is shown in FIG. 5. In the side view the securing hooks 23 can be seen which grip the cable shoe (not shown in the drawing) and attach the securing part 13A to the latter. Once again the stepped embodiment of the inner wall of the U-shaped securing part 13A can be seen. The elasticity for the click-on attachment process can be achieved for example through an embodiment made of elastic plastic.

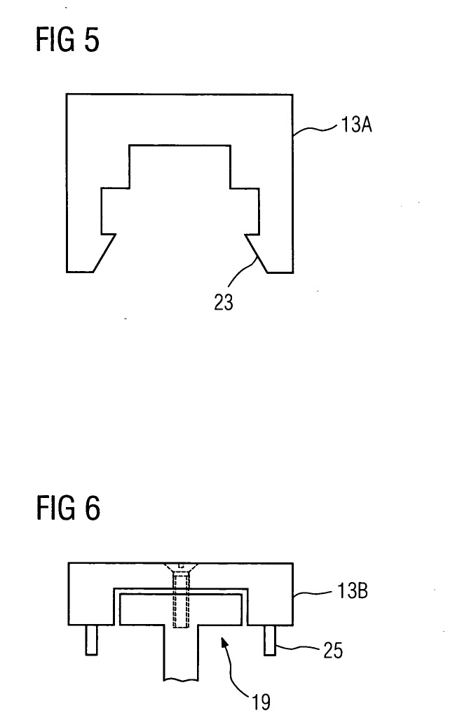

FIG. 6 shows a further alternative embodiment of a screw-on securing part 13B which features pins 25 which allow fixing relative to the cable shoe (not shown in the drawing) by projecting into holes drilled in the cable shoe.

1.-9. (canceled)

10. A securing part for preventing a screw connection from working loose, comprising, the screw connection comprising a screw, a first connection part, and a second connection part, the first connection part screwed to the second connection part using the screw, the securing part comprising an attachment unit for attaching the securing part to at least one of the first and second connection parts or to the screw, the securing part sized and configured to be fixed in spatial position relative to either the first or the second connection part and relative to the screw when the screw connection is in a secured connected state.

11. The securing part in accordance with claim 10, wherein the attachment unit comprises a securing screw for screwing the securing part to a screw head of the screw.

12. The securing part in accordance with claim 11, wherein at least a first area of the securing part is:
arranged beside the screw relative to a longitudinal axis of the screw; and
in contact with the screw head, when the screw connection is in the secured connected state.

13. The securing part in accordance with claim 12, wherein the first area is a first flat surface arranged beside a flat side surface of the screw head such that the screw is prevented from turning.

14. The securing part in accordance with claim 10, wherein at least a second area of the securing part is in contact with either the first or second connection part such that a movement of the first respectively second connection part relative to the securing part is prevented.

15. The securing part in accordance with claim 14, wherein the second area is a second flat surface arranged beside the first respectively second connection part.

16. The securing part in accordance with claim 15, wherein the first respectively second connection part is a plate having side surfaces.

17. The securing part in accordance with claim 16, wherein the plate is a cable shoe.

18. The securing part in accordance with claim 14, wherein the second area is shaped as a pin projecting into cutouts of the first respectively second connection part.

19. The securing part in accordance with claim 11, wherein the securing part has an angular shape having first and second side areas, the first side area sized and configured to be screwed into a thread of the screw head and the second side area extending over the screw head and over the first respectively second connection part adjoining the screw head such that the screw head and the first respectively second connection part are fixed to each other.

20. The securing part in accordance with claim 11, wherein
the securing part has an U-shape, and
the screw head is fixed at opposite sides of the crew head to the first respectively second connection part adjoining the screw head.

21. The securing part in accordance with claim 18, wherein the U-shaped securing part has two blades embodied as click elements having securing hooks.
